(19) United States
(12) Patent Application Publication
(10) Pub. No.: US 2026/0120313 A1
(43) Pub. Date: Apr. 30, 2026

(54) METHOD AND APPARATUS FOR TRACKING OBJECTS

(71) Applicant: QUALCOMM Incorporated, San Diego, CA (US)

(72) Inventors: Robert Peter VIEHAUSER, Bad Hofgastein (AT); Nicolas David PERRICHOT, Wien (AT); Markus EDER, Salzburg (AT)

(21) Appl. No.: 18/932,453

(22) Filed: Oct. 30, 2024

(51) Int. Cl. G06T 7/73; G06T 19/00; G06T 19/20

(52) U.S. Cl. CPC G06T 7/73; G06T 19/006; G06T 19/20; G06T 2219/2016

(57) ABSTRACT

Systems and techniques are described herein for tracking objects. For instance, a method for tracking objects is provided. The method may include obtaining input image data representative of a scene, the input image data including an image of an object displayed on a physical display; determining an object-to-camera transformation based on the image of the object displayed by the physical display as depicted in the input image data; determining a display-to-camera transformation based on the physical display as depicted in the input image data; and generating output image data representative of the scene based on the input image data, the object-to-camera transformation, and the display-to-camera transformation, wherein the output image data is to be displayed at a second display.

### TECHNICAL FIELD

The present disclosure generally relates to tracking objects. For example, aspects of the present disclosure include systems and techniques for tracking objects based on images of the objects.

### BACKGROUND

An extended reality (XR) (e.g., virtual reality (VR), augmented reality (AR), and/or mixed reality (MR)) system may provide a user with a virtual experience by displaying virtual content at a display mostly, or entirely, filling a user's field of view. Additionally or alternatively, an XR system may provide a user with an augmented-reality or mixed-reality experience by displaying virtual content overlaid onto, or alongside, a user's field of view of the real world (e.g., using a see-through or pass-through display).

XR systems typically include a display (e.g., a head-mounted display (HMD) or smart glasses), an image-capture device proximate to the display, and a processing device. In such XR systems, the image-capture device may capture images indicative of a field of view of user, the processing device may generate virtual content based on the field of view of the user and/or objects within the field of view, and the display may display the virtual content within the field of view of the user.

In some cases, XR systems may track poses (including positions and orientations) of objects in the physical world (e.g., “real-world objects”). For example, an XR system may use images of real-world objects to calculate poses of the real-world objects. In some examples, the XR system may use the tracked poses of one or more respective real-world objects to render virtual content relative to the real-world objects in a convincing manner. For instance, such XR systems may use the pose information to match virtual content with a spatio-temporal state of the real-world objects. In one illustrative example, by tracking a real-world toy fire truck, an XR system may render a virtual fireman and display the virtual fireman in relation to (e.g., riding on) the real-world toy fire truck.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for tracking objects. According to at least one example, a method is provided for tracking objects. The method includes: obtaining input image data representative of a scene, the input image data including an image of an object displayed on a physical display; determining an object-to-camera transformation based on the image of the object displayed by the physical display as depicted in the input image data; determining a display-to-camera transformation based on the physical display as depicted in the input image data; and generating output image data representative of the scene based on the input image data, the object-to-camera transformation, and the display-to-camera transformation, wherein the output image data is to be displayed at a second display.

In another example, an apparatus for tracking objects is provided that includes at least one memory and at least one processor (e.g., configured in circuitry) coupled to the at least one memory. The at least one processor configured to: obtain input image data representative of a scene, the input image data including an image of an object displayed on a physical display; determine an object-to-camera transformation based on the image of the object displayed by the physical display as depicted in the input image data; determine a display-to-camera transformation based on the physical display as depicted in the input image data; and generate output image data representative of the scene based on the input image data, the object-to-camera transformation, and the display-to-camera transformation, wherein the output image data is to be displayed at a second display.

In another example, a non-transitory computer-readable medium is provided that has stored thereon instructions that, when executed by one or more processors, cause the one or more processors to: obtain input image data representative of a scene, the input image data including an image of an object displayed on a physical display; determine an object-to-camera transformation based on the image of the object displayed by the physical display as depicted in the input image data; determine a display-to-camera transformation based on the physical display as depicted in the input image data; and generate output image data representative of the scene based on the input image data, the object-to-camera transformation, and the display-to-camera transformation, wherein the output image data is to be displayed at a second display.

In another example, an apparatus for tracking objects is provided. The apparatus includes: means for obtaining input image data representative of a scene, the input image data including an image of an object displayed on a physical display; means for determining an object-to-camera transformation based on the image of the object displayed by the physical display as depicted in the input image data; means for determining a display-to-camera transformation based on the physical display as depicted in the input image data; and means for generating output image data representative of the scene based on the input image data, the object-to-camera transformation, and the display-to-camera transformation, wherein the output image data is to be displayed at a second display.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a block diagram illustrating an architecture of an example extended reality (XR) system, in accordance with some aspects of the disclosure;

FIG. 3 is a diagram illustrating an example system in which an XR device captures an image of an object, according to various aspects of the present disclosure;

FIG. 4 is a diagram illustrating an example pipeline, according to various aspects of the present disclosure;

FIG. 5 is a diagram illustrating an example system in which an XR device captures an image of a display, according to various aspects of the present disclosure;

FIG. 6 is a diagram illustrating an example pipeline, according to various aspects of the present disclosure;

FIG. 7 includes an image of an object including virtual content and an image of a display displaying an image of object, according to various aspects of the present disclosure;

FIG. 8 is a diagram illustrating an example system in which an XR device determines and/or applies a transformation

$${𝕋}_{o}^{{c}_{d}} ,$$

according to various aspects of the present disclosure;

FIG. 9A is a diagram illustrating an example system in which an XR device determines and/or applies a transformation

$${𝕋}_{o}^{{c}_{d}}$$

and a transformation

$${𝕋}_{o}^{{c}_{s}} ,$$

according to various aspects of the and a transformation present disclosure;

FIG. 9B includes an alternate view of the system of FIG. 9A in which the display displays a QR code, according to various aspects of the present disclosure;

FIG. 10 is a flow diagram illustrating an example process for tracking objects, in accordance with aspects of the present disclosure;

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As described above, an extended reality (XR) system or device may provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, tablets, or smartphones among others. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a real-world pig), by AR content displayed relative to the physical object (e.g., informational virtual content displayed near a sign on a building, a virtual monster anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person). Additionally, or alternatively, MR can include a VR headset with AR capabilities, for instance, an MR system may perform video pass-through (to mimic AR glasses) by passing images (and/or video) of some real-world objects, like a keyboard and/or a monitor, and/or taking real-word geometry (e.g., walls, tables) into account. For example, in a game, the structure of a room can be retextured to according to the game, but the geometry may still be based on the real-world geometry of the room.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical sec-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In order to provide and/or display virtual content, XR systems may track the XR system and/or real-world object. Degrees of freedom (DoF) refer to the number of basic ways a rigid object can move through three-dimensional (3D) space. In some cases, XR systems and/or real-world object can be tracked through six different DoF. The six degrees of freedom include three translational degrees of freedom corresponding to translational movement along three perpendicular axes. The three axes can be referred to as x, y, and z axes. The six degrees of freedom include three rotational degrees of freedom corresponding to rotational movement around the three axes, which can be referred to as roll pitch, and yaw.

In the context of systems that track movement through an environment, such as XR systems, degrees of freedom can refer to which of the six degrees of freedom the system is capable of tracking. 3DoF systems generally track the three rotational DoF-pitch, yaw, and roll. A 3DoF headset, for instance, can track the user of the headset turning their head left or right, tilting their head up or down, and/or tilting their head to the left or right. 6DoF systems can track the three translational DoF as well as the three rotational DoF. Thus, a 6DoF headset, for instance, can track the user moving forward, backward, laterally, and/or vertically in addition to tracking the three rotational DoF.

An XR system may track changes in pose (e.g., changes in translations and changes of orientation, including changes in roll, pitch, and/or yaw) of respective elements of the XR system (e.g., a display and/or a camera of the XR system) in six DoF. In the present disclosure, the term “pose,” and like terms, may refer to position and orientation (including roll, pitch, and yaw). The XR system may relate the poses (e.g., including position and orientation, where orientation can include roll, pitch, and yaw) of the respective elements of the XR system to a reference coordinate system (which may alternatively be referred to as a world coordinate system). The reference coordinate system may be stationary and may be associated with the real-world environment in which the XR system is being used. Tracking the poses of the elements of the XR system relative to the reference coordinate system may allow virtual content to be displayed accurately relative to the real-world environment. For example, by tracking a display of the XR system, the XR system may be able to position virtual content in the display, as the display changes pose, such that the virtual content remains stationary in the field of view of a viewer of the display.

In some cases, a display of an XR system (e.g., an HMD, AR glasses, etc.) may include one or more inertial measurement units (IMUs) and may use measurements from the IMUs determine a pose of the display. Based on the determined pose, the XR system may generate and/or display virtual content. The XR system may change the location of the virtual content on the display as the display changes pose such that the virtual content maintains correspondence to the real-world position (e.g., between the user's eye and the real-world position) despite the display changing pose.

Further some XR systems may use visual simultaneous localization and mapping (VSLAM which may also be referred to as simultaneous localization and mapping (SLAM)) computational-geometry techniques to track a pose of an element (e.g., a display) of such XR systems. In VSLAM, a device can construct and update a map of an unknown environment based on images captured by the device's camera. The device can keep track of the device's pose within the environment (e.g., location and/or orientation) as the device updates the map. For example, the device can be activated in a particular room of a building and can move throughout the interior of the building, capturing images. The device can map the environment, and keep track of its location in the environment, based on tracking where different objects in the environment appear in different images.

Thus, an XR system may track the pose (e.g., in six DoF) of a display of the XR system (which may be coupled to a camera of the XR system) in the reference coordinate system using data from IMUs and/or SLAM techniques. Tracking the pose of the display may allow the XR system to display virtual content relative to the real world.

Additionally, as described above, in some cases, XR systems may track poses of objects in the physical world (e.g., “real-world objects”). For example, an XR system may use images of real-world objects to calculate poses of the real-world objects. In some examples, the XR system may use the tracked poses of one or more respective real-world objects to render virtual content relative to the real-world objects in a convincing manner. For example, such XR systems may use the pose information to match virtual content with the spatio-temporal state of the real-world objects. For example, by tracking a real-world toy fire truck, an XR system may render a virtual fireman and display the virtual fireman in relation to (e.g., riding on) the real-world toy fire truck. In some examples, XR systems may track other objects for other purposes. For example, an XR system may track hands of a user to allow the user to interact with virtual content based on the position of the user's hands.

It may be desirable to be able to track an object based on an image (or video) of the object. For instance, it may be desirable to anchor virtual content to an image of an object. For example, for developing, testing, or experiencing AR/XR a user may not have an actual object associated with the AR/XR content at hand. For example, a virtual-content developer may be developing virtual content to display relative to the Eiffel tower and may wish to view the virtual content relative to the Eiffel tower to test the anchoring of the virtual content but, the developer may not be near the Eiffel tower. As another example, a user, or application developer, may want to show registered content relative to an object, but the user may not have the object.

Systems, apparatuses, methods (also referred to as processes), and computer-readable media (collectively referred to herein as “systems and techniques”) are described herein for tracking objects. For example, the systems and techniques described herein may track objects through images of the objects.

For example, returning to the example of the Eiffel tower, the systems and techniques may allow the virtual-content developer to use an XR device to view an image of the Eiffel tower (e.g., a poster or a display displaying an image or video of the Eiffel tower). The systems and techniques may track the Eiffel tower in the image. In some aspects, because the systems and techniques have tracked the Eiffel tower, the systems and techniques may further render virtual content relative to the Eiffel tower as if the virtual content were present in the image (e.g., anchoring the virtual content to the Eiffel tower as if the Eiffel tower were present).

Returning to the example of the registered content, the application developer may have a virtual version of a 3D model of the object. The application developer may render a view of the 3D model of the object using a 3D viewer/a video/images on a computer screen. The application developer may observe the screen through an XR headset. The systems and techniques may track the object based on the images of the object. In some aspects, because the systems and techniques have tracked the object, the systems and techniques may further render virtual content relative to the object as if the virtual content were present in the image of the object (e.g., anchoring the virtual content to the object as if the object were present).

The systems and techniques may include a tracking algorithm that may perform as if the actual object was observed. For example, the tracking algorithm may track objects based on images of objects as if the actual objects were present. Also, the systems and techniques may, based on the tracking, anchor virtual content to appear as if the real object was captured/rendered with the virtual content in place.

Various aspects of the application will be described with respect to the figures below.

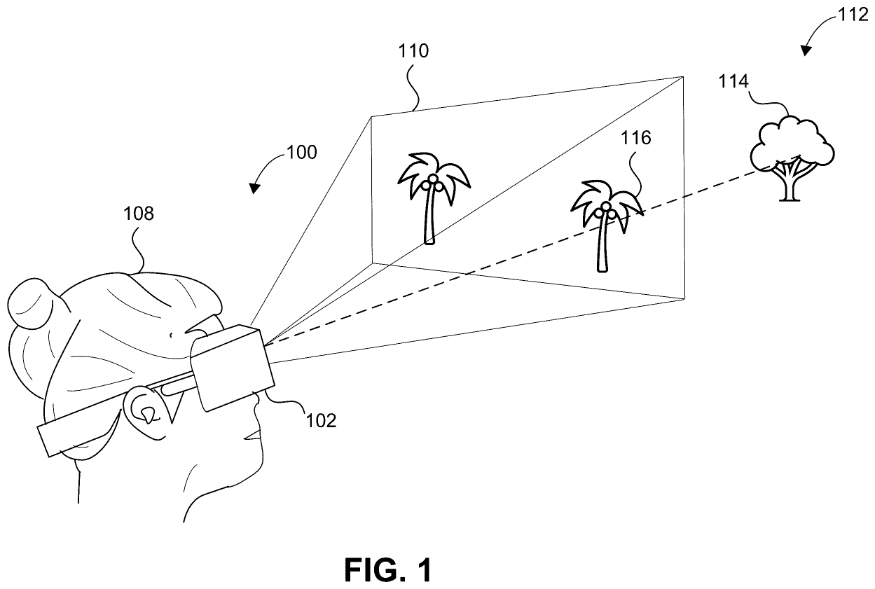

FIG. 1 is a diagram illustrating an example extended-reality (XR) system 100, according to aspects of the disclosure. As shown, XR system 100 includes an XR device 102. XR device 102 may implement, as examples, image-capture, object-detection, object-tracking, gaze-tracking, view-tracking, localization (e.g., determining a location of XR device 102), pose-tracking (e.g., tracking a pose of XR device 102 and/or a pose of one or more objects in scene 112), content-generation, content-rendering, computational, communicational, and/or display aspects of extended reality, including virtual reality (VR), augmented reality (AR), and/or mixed reality (MR).

For example, XR device 102 may include one or more scene-facing cameras that may capture images of a scene 112 in which a user 108 uses XR device 102. XR device 102 may detect and/or track objects (e.g., object 114) in scene 112 based on the images of scene 112. In some aspects, XR device 102 may include one or more user-facing cameras that may capture images of eyes of user 108. XR device 102 may determine a gaze of user 108 based on the images of user 108. In some aspects, XR device 102 may determine an object of interest (e.g., object 114) in scene 112 (e.g., based on the gaze of user 108, based on object recognition, and/or based on a received indication regarding object 114). XR device 102 may obtain and/or render XR content 116 (e.g., text, images, and/or video) for display at XR device 102. XR device 102 may display XR content 116 to user 108 (e.g., within a field of view 110 of user 108). In some aspects, XR content 116 may be based on the object of interest. For example, XR content 116 may be an altered version of object 114. In some aspects, XR device 102 may display XR content 116 in relation to the view of user 108 of the object of interest. For example, XR device 102 may overlay XR content 116 onto object 114 in field of view 110. In any case, XR device 102 may overlay XR content 116 (whether related to object 114 or not) onto the view of user 108 of scene 112.

In a “see-through” or “transparent” configuration, XR device 102 may include a transparent surface (e.g., optical glass) such that XR content 116 may be displayed on (e.g., by being projected onto) the transparent surface to overlay the view of user 108 of scene 112 as viewed through the transparent surface. In a “pass-through” configuration or a “video see-through” configuration, XR device 102 may include a scene-facing camera that may capture images of scene 112. XR device 102 may display images or video of scene 112, as captured by the scene-facing camera, and XR content 116 overlaid on the images or video of scene 112.

In various examples, XR device 102 may be, or may include, a head-mounted device (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, display, and/or smart glass).

In some aspects, XR device 102 may be, or may include, two or more devices. For example, XR device 102 may include a display device and a processing device. The display device may capture and/or generate data, such as image data (e.g., from user-facing cameras and/or scene-facing cameras) and/or motion data (from an inertial measurement unit (IMU)). The display device may provide the data to the processing device, for example, through a wireless connection between the display device and the processing device. The processing device may process the data and/or other data (e.g., data received from another source). Further, the processing unit may generate (or obtain) XR content 116 to be displayed at the display device. The processing device may provide the generated XR content 116 to the display device, for example, through the wireless connection. And the display device may display XR content 116 in field of view 110 of user 108.

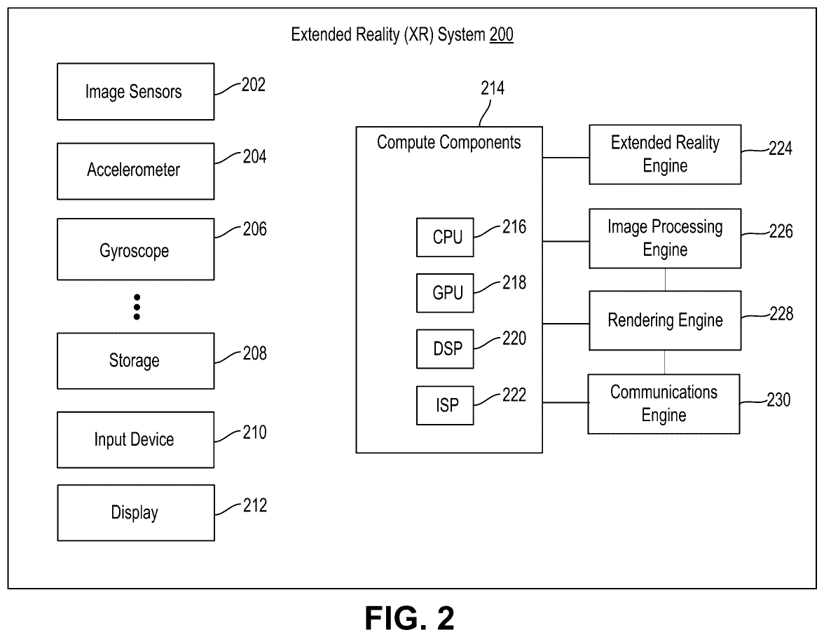

FIG. 2 is a diagram illustrating an architecture of an example extended reality (XR) system 200, in accordance with some aspects of the disclosure. XR system 200 may execute XR applications and implement XR operations.

In this illustrative example, XR system 200 includes one or more image sensors 202, an accelerometer 204, a gyroscope 206, storage 208, an input device 210, a display 212, Compute components 214, an XR engine 226, an image processing engine 228, a rendering engine 230, and a communications engine 232. It should be noted that the components 202-232 shown in FIG. 2 are non-limiting examples provided for illustrative and explanation purposes, and other examples may include more, fewer, or different components than those shown in FIG. 2. For example, in some cases, XR system 200 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 2. While various components of XR system 200, such as image sensor 202, may be referenced in the singular form herein, it should be understood that XR system 200 may include multiple of any component discussed herein (e.g., multiple image sensors 202).

Display 212 may be, or may include, a glass, a screen, a lens, a projector, and/or other display mechanism that allows a user to see the real-world environment and also allows XR content to be overlaid, overlapped, blended with, or otherwise displayed thereon.

XR system 200 may include, or may be in communication with, (wired or wirelessly) an input device 210. Input device 210 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 202 may capture images that may be processed for interpreting gesture commands.

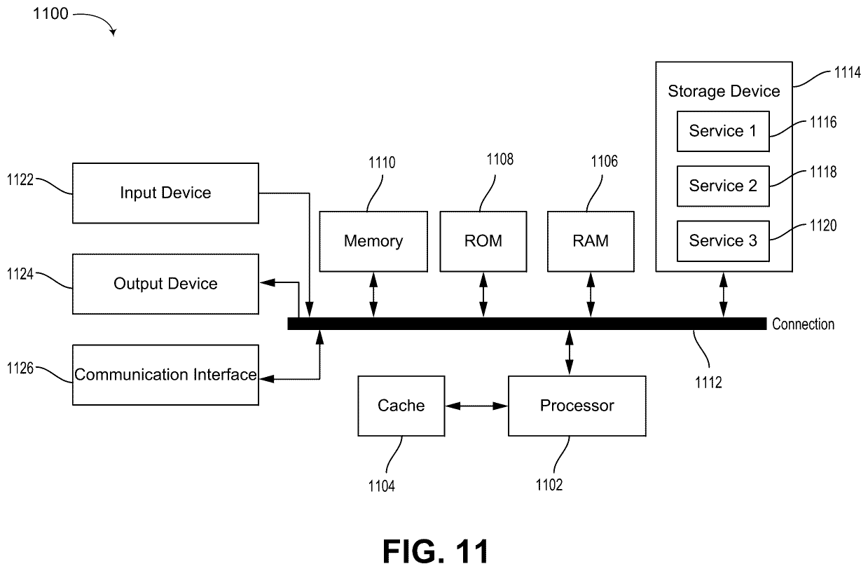

XR system 200 may also communicate with one or more other electronic devices (wired or wirelessly). For example, communications engine 232 may be configured to manage connections and communicate with one or more electronic devices. In some cases, communications engine 232 may correspond to communication interface 1126 of FIG. 11.

In some implementations, image sensors 202, accelerometer 204, gyroscope 206, storage 208, display 212, compute components 214, XR engine 226, image processing engine 228, and rendering engine 230 may be part of the same computing device. For example, in some cases, image sensors 202, accelerometer 204, gyroscope 206, storage 208, display 212, compute components 214, XR engine 226, image processing engine 228, and rendering engine 230 may be integrated into an HMD, extended reality glasses, smartphone, laptop, tablet computer, gaming system, and/or any other computing device. However, in some implementations, image sensors 202, accelerometer 204, gyroscope 206, storage 208, display 212, compute components 214, XR engine 226, image processing engine 228, and rendering engine 230 may be part of two or more separate computing devices. For instance, in some cases, some of the components 202-232 may be part of, or implemented by, one computing device and the remaining components may be part of, or implemented by, one or more other computing devices. For example, such as in a split perception XR system, XR system 200 may include a first device (e.g., an HMD), including display 212, image sensor 202, accelerometer 204, gyroscope 206, and/or one or more compute components 214. XR system 200 may also include a second device including additional compute components 214 (e.g., implementing XR engine 226, image processing engine 228, rendering engine 230, and/or communications engine 232). In such an example, the second device may generate virtual content based on information or data (e.g., images, sensor data such as measurements from accelerometer 204 and gyroscope 206) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 208 may be any storage device(s) for storing data. Moreover, storage 208 may store data from any of the components of XR system 200. For example, storage 208 may store data from image sensor 202 (e.g., image or video data), data from accelerometer 204 (e.g., measurements), data from gyroscope 206 (e.g., measurements), data from compute components 214 (e.g., processing parameters, preferences, virtual content, rendering content, scene maps, tracking and localization data, object detection data, privacy data, XR application data, face recognition data, occlusion data, etc.), data from XR engine 226, data from image processing engine 228, and/or data from rendering engine 230 (e.g., output frames). In some examples, storage 208 may include a buffer for storing frames for processing by compute components 214.

Compute components 214 may be, or may include, a central processing unit (CPU) 216, a graphics processing unit (GPU) 218, a digital signal processor (DSP) 220, an image signal processor (ISP) 222, a neural processing unit (NPU) 224, which may implement one or more trained neural networks, and/or other processors. Compute components 214 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 214 may implement (e.g., control, operate, etc.) XR engine 226, image processing engine 228, and rendering engine 230. In other examples, compute components 214 may also implement one or more other processing engines.

Image sensor 202 may include any image and/or video sensors or capturing devices. In some examples, image sensor 202 may be part of a multiple-camera assembly, such as a dual-camera assembly. Image sensor 202 may capture image and/or video content (e.g., raw image and/or video data), which may then be processed by compute components 214, XR engine 226, image processing engine 228, and/or rendering engine 230 as described herein.

In some examples, image sensor 202 may capture image data and may generate images (also referred to as frames) based on the image data and/or may provide the image data or frames to XR engine 226, image processing engine 228, and/or rendering engine 230 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 202 (and/or other camera of XR system 200) may be configured to also capture depth information. For example, in some implementations, image sensor 202 (and/or other camera) may include an RGB-depth (RGB-D) camera. In some cases, XR system 200 may include one or more depth sensors (not shown) that are separate from image sensor 202 (and/or other camera) and that may capture depth information. For instance, such a depth sensor may obtain depth information independently from image sensor 202. In some examples, a depth sensor may be physically installed in the same general location or position as image sensor 202 but may operate at a different frequency or frame rate from image sensor 202. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 200 may also include other sensors in its one or more sensors. The one or more sensors may include one or more accelerometers (e.g., accelerometer 204), one or more gyroscopes (e.g., gyroscope 206), and/or other sensors. The one or more sensors may provide velocity, orientation, and/or other position-related information to compute components 214. For example, accelerometer 204 may detect acceleration by XR system 200 and may generate acceleration measurements based on the detected acceleration. In some cases, accelerometer 204 may provide one or more translational vectors (e.g., up/down, left/right, forward/back) that may be used for determining a position or pose of XR system 200. Gyroscope 206 may detect and measure the orientation and angular velocity of XR system 200. For example, gyroscope 206 may be used to measure the pitch, roll, and yaw of XR system 200. In some cases, gyroscope 206 may provide one or more rotational vectors (e.g., pitch, yaw, roll). In some examples, image sensor 202 and/or XR engine 226 may use measurements obtained by accelerometer 204 (e.g., one or more translational vectors) and/or gyroscope 206 (e.g., one or more rotational vectors) to calculate the pose of XR system 200. As previously noted, in other examples, XR system 200 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 200, using a combination of one or more accelerometers, one or more gyroscopes, and/or one or more magnetometers. In some examples, the one or more sensors may output measured information associated with the capture of an image captured by image sensor 202 (and/or other camera of XR system 200) and/or depth information obtained using one or more depth sensors of XR system 200.

The output of one or more sensors (e.g., accelerometer 204, gyroscope 206, one or more IMUs, and/or other sensors) can be used by XR engine 226 to determine a pose of XR system 200 (also referred to as the head pose) and/or the pose of image sensor 202 (or other camera of XR system 200). In some cases, the pose of XR system 200 and the pose of image sensor 202 (or other camera) can be the same. The pose of image sensor 202 refers to the position and orientation of image sensor 202 relative to a frame of reference (e.g., with respect to a field of view 110 of FIG. 1). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 202 to track a pose (e.g., a 6DoF pose) of XR system 200. For example, the device tracker can fuse visual data (e.g., using a visual tracking solution) from the image data with inertial data from the measurements to determine a position and motion of XR system 200 relative to the physical world (e.g., the scene) and a map of the physical world. As described below, in some examples, when tracking the pose of XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or XR system 200 as a whole can be determined and/or tracked by compute components 214 using a visual tracking solution based on images captured by image sensor 202 (and/or other camera of XR system 200). For instance, in some examples, compute components 214 can perform tracking using computer vision-based tracking, model-based tracking, and/or simultaneous localization and mapping (SLAM) techniques. For instance, compute components 214 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or XR system 200 relative to that map. The map can be referred to as a SLAM map which can be three-dimensional (3D). The SLAM techniques can be performed using color or grayscale image data captured by image sensor 202 (and/or other camera of XR system 200) and can be used to generate estimates of 6DoF pose measurements of image sensor 202 and/or XR system 200. Such a SLAM technique configured to perform 6DoF tracking can be referred to as 6DoF SLAM. In some cases, the output of the one or more sensors (e.g., accelerometer 204, gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 214 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 214 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

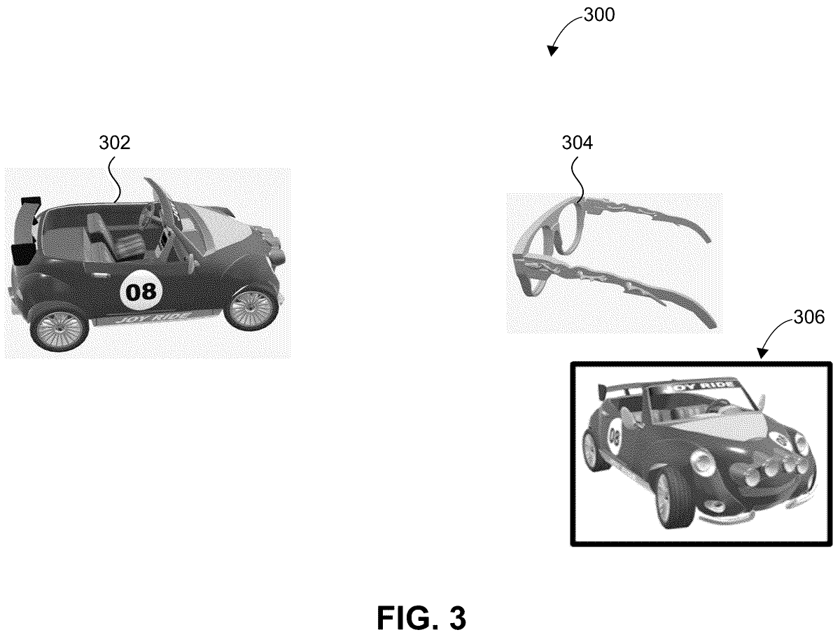

FIG. 3 is a diagram illustrating an example system 300 in which an XR device 304 captures an image 306 of an object 302, according to various aspects of the present disclosure. In general, tracking algorithms determine 3D-2D projections. 6DoF pose estimation of a real object may use a camera model that may be known a priori (e.g., based on components and calibrations of the camera). Additionally or alternatively, the camera model may be updated during usage of the system. A tracking algorithm may determine a projection based on the camera model. The projection may be, or may include, a mathematical description of how real 3D scenes are projected onto the image sensor of the camera. Observing a real object via a calibrated camera of an AR/XR device can be modelled accurately by a 6DoF pose and a camera projection model.

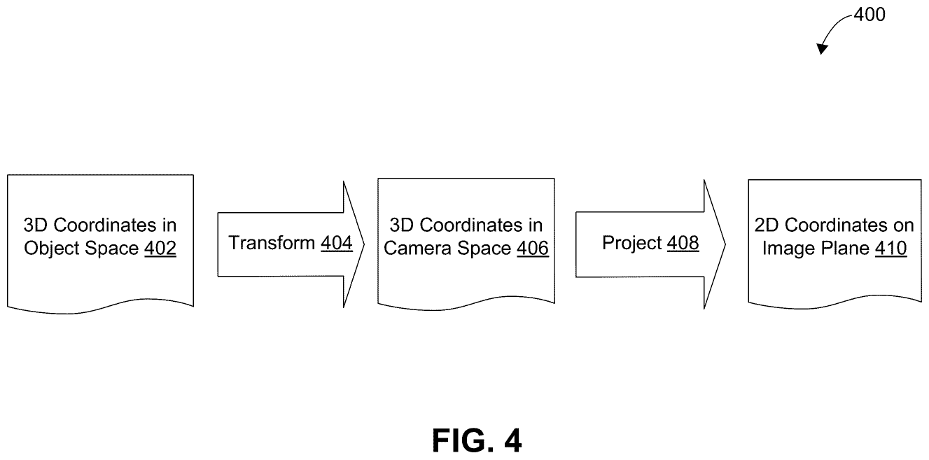

FIG. 4 is a diagram illustrating an example pipeline 400, according to various aspects of the present disclosure. Pipeline 400 may implement 3D-to-2D camera-frame projection operations.

In a forward path, an image of an object may be captured by a camera and the image of the object may be displayed at a display. In capturing the image of the object, the camera May generate a 2D image of the 3D object. In displaying the captured image, the 2D image may be displayed at a display in 2D. The captured image may be distorted (e.g., based on a lens of the camera that captured the image). To display the image, the image may be adjusted to account for the distortions.

The device that captures the image of the object may, or may not, be the same as the device that displays the image of the object. For example, in some cases, a device including a camera and a display may capture the image of the object using the camera and display the image of the object at the display. The device may display the image of the object as it is captured, or at a later time. In other cases, a camera or a first device may capture the image of the object and a second device may display the image of the object.

In a reverse path, the device may track the object (e.g., determine a pose of the object). For example, the device may determine a transformation between 3D coordinates in an object coordinate system (e.g., a coordinate system defined based on the object) and 3D coordinates in a camera coordinate system (e.g., a coordinate system defined based on the camera). The transformation may describe how points in a 3D space relative to the object may be represented in a 3D space relative to the camera. For instance, a given point in a scene may be 10 centimeters in front of, 10 centimeters to the right of, and 10 centimeters above of a defined origin of an object coordinate system. The origin may be, for example, the center of the object. The transformation may define how the given point is described in a coordinate system of the camera (e.g., 5 meters in front of, 1 meter below, and 1 meter to the left of the camera). The transformation may include translation (e.g., in three orthogonal degrees of freedom, such as x, y, and z) and orientation (e.g., in three rotational degrees of freedom, such as roll, pitch, and yaw).

3D coordinates in object space 402 represents points in space as described by a coordinate system relative to an object (e.g., “object space”). Transform 404 represents a transformation from the coordinate system relative to the object to a coordinate system relative to a camera which captures an image of the space. 3D coordinates in camera space 406 represents points in space as described by a coordinate system relative to the camera (e.g., “camera space”). For example, the transformation may describe how 3D coordinates in object space 402 may be transformed (e.g., at transform 404) to become 3D coordinates in camera space 406. The transformation may be a matrix or other mathematical function. At transform 404, pipeline 400 may multiply (e.g., matrix multiply) 3D coordinates in object space 402 by the transformation matrix to generate 3D coordinates in camera space 406.

A tracker may update the transformation over time. For example, as the object on which the object space is based moves and/or reorients and/or as the camera on which the camera space is based moves and/or reorients, the tracker may update the transformation to account for changes in the relationship between the object space and the camera space. For example, the tracker may determine the camera space such that the camera space moves and/or reorients with the camera and the tracker may determine the object space such that the object space moves and/or reorients with the object. The tracker may update the transformation as the object space and the camera space move relative to one another.

Further, in the reverse path, the device may obtain a projection based on a camera model which may include intrinsic parameters of a camera of the device that captured the image, such as a focal length of the lens and/or any distortions of the lens. The projection may be determined a priori based on the camera, for example, through a calibration process. Additionally or alternatively, the projection may be updated during usage of the camera.

The projection may describe how points in a 3D space relative to the camera (e.g., camera space) may be rendered in images generated by the camera. For example, the projection may define how 3D coordinates in camera space 406 are projected (e.g., at project 408) to become 2D coordinates on image plane 410. As an example, the projection may define how a point that is 10 meters away in a z-dimension, (e.g., a line extending directly in front of the camera), 1 meter away in an orthogonal x-dimension, and 2 meters away in an orthogonal y-dimension will appear in an image (e.g., at what pixel position of the image will the point be represented). The projection may be a matrix or other mathematical function. At project 408, pipeline 400 may multiply (e.g., matrix multiply) 3D coordinates in camera space 406 by the projection to generate 2D coordinates on image plane 410.

Transform 404 and project 408 may be used to anchor virtual content to an object. For example, an XR system may determine virtual content to render relative to the object. The XR system may simulate the virtual content in the object space at the desired position relative to the object. For example, the system may simulate 3D wings anchored to the back of a real-world pig. The system may determine that the wings are to be anchored to the back of the real-world pig. The system may determine where (and at what orientation) the wing should be in the object space (e.g., 10 centimeters in a y direction relative to the center of the pig at 0 degrees yaw).

The system may then transform (e.g., using the transformation at transform 404) the simulated virtual content from the object space into the camera space. For example, the system may multiply the 3D coordinates of the points making up the 3D virtual wings by the transformation.

Further, the system may project (e.g., using the projection at project 408) the 3D virtual wings from the camera space into an image plane. In projecting the 3D virtual content, the system may render pixels representing the virtual wings in 2D in the image plane.

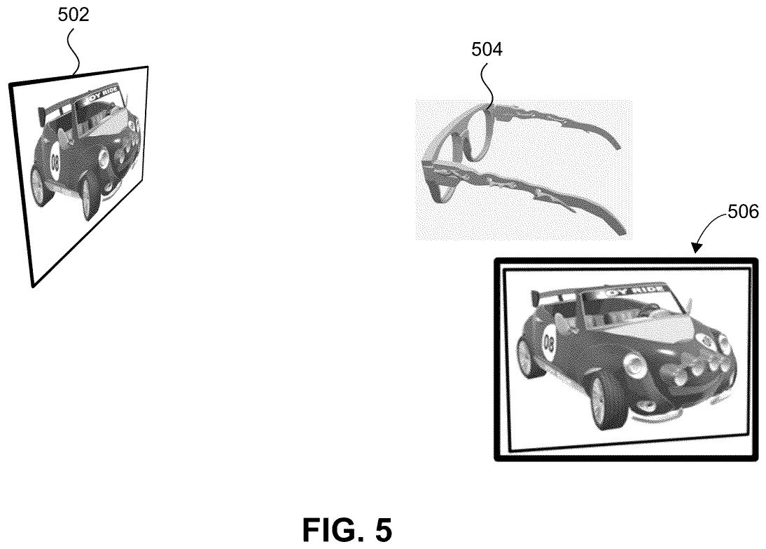

FIG. 5 is a diagram illustrating an example system 500 in which an XR device 504 captures an image 506 of a display 502, according to various aspects of the present disclosure. Display 502 displays an image of an object. Observing a rendered 3D object on a display with a camera is not the same as observing the real object with the camera because multiple projections and pose changes apply. Trying to track an object, through conventional tracking techniques, based on an image of the object may lead to degradation of tracking accuracy, or even failure of the system. For example, applying pipeline 400 of FIG. 4, to the object as displayed by display 502 and viewed by XR device 504, may result in poor tracking accuracy or an inability to track the object.

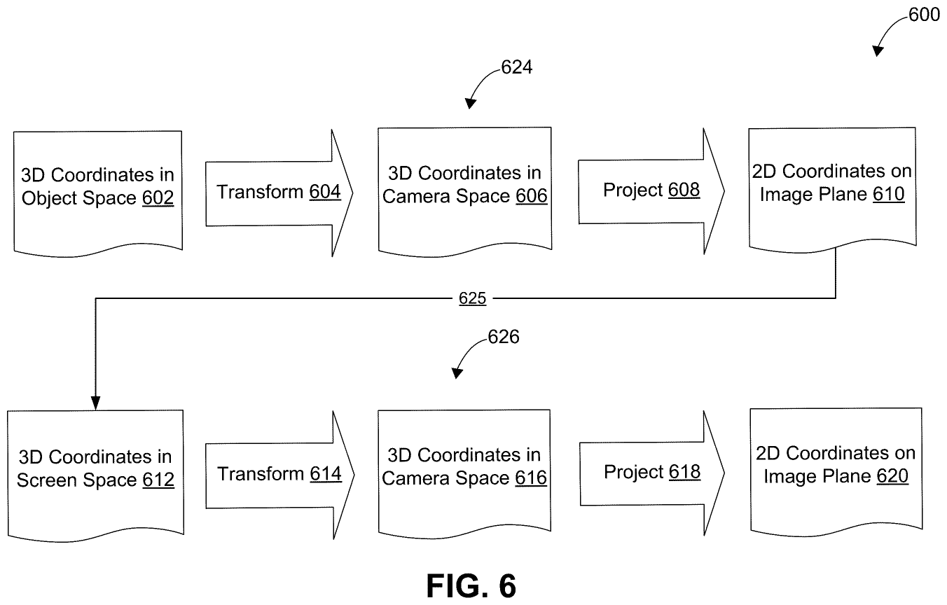

FIG. 6 is a diagram illustrating an example pipeline 600, according to various aspects of the present disclosure. Pipeline 600 may include two instances of 3D-to-2D camera-frame projection operations. For example, pipeline 600 may include a pipeline 624 in which a camera may capture an image of an object and a display may display the image of the object. The camera and the display may, or may not, be part of the same device. Further, the camera may capture the image at one time and the display may display the image at a later time. For instance, display 502 may display an image of an object. The image of the object may have been captured by display 502 or by another device. The image of the object may have been captured prior to display 502 displaying the image.

3D coordinates in object space 602 may be the same as, or may be substantially similar to, 3D coordinates in object space 402 of FIG. 4. Transform 604 may be the same as, may be substantially similar to, and/or may perform the same, or substantially the same, operations as transform 404 of FIG. 4. 3D coordinates in camera space 606 may be the same as, or may be substantially similar to, 3D coordinates in camera space 406 of FIG. 4. Project 608 may be the same as, may be substantially similar to, and/or may perform the same, or substantially the same, operations as project 408 of FIG. 4. 2D coordinates on image plane 610 may be the same as, or may be substantially similar to, 2D coordinates on image plane 410 of FIG. 4.

In pipeline 600, a device that captures the image of the object and/or the device that displays the image of the object may, or may not, determine a transformation or perform transformation operations at transform 604. However, the device that captures the image or the device that displays the image may determine a projection and perform projections operations at project 608. For example, the device that captures the image or the device that displays the image may determine a projection describing how to translate pixels captured by the camera into the display space to account for distortions of the camera based on the camera model.

Additionally, pipeline 600 may include a pipeline 626 in which a device (e.g., XR device 504) may capture an image of the display (e.g., display 502) and display an image of the display (including the image of the object as displayed by the display) (e.g., image 506) at a display of the device.

Between pipeline 624 and pipeline 626, pipeline 600 includes mapping 625 that may map the 2D pixel coordinates of display to 3D coordinates in the system of the display. For example, the output could be 3D coordinates in metric units, where the z-component is 0 in the case the screen is defined as x/y plane. In some cases, the XR device may infer mapping 625 (which may include a scaling and an optional shift of the coordinate center). Inferring mapping may involve determining the physical size of the screen, which may be accomplished, for example, by reading a configuration file, determining the screen type and looking up a size in a database, requesting a screen size from the screen, and/or user input.

In general, pipeline 626 may be the same as, may be substantially similar to, and/or may perform the same, or substantially the same, operations as pipeline 624. For example, 3D coordinates in screen space 612 may be the same as, or may be substantially similar to, 3D coordinates in object space 602. However, whereas 3D coordinates in object space 602 represents 3D coordinates of points of an object, in a coordinate system defined based on the object (e.g., “object space”), 3D coordinates in screen space 612 may represent 3D coordinates of points of a screen (e.g., display 502), in a coordinate space device defined based on the screen (e.g., “screen space”). Screen space may describe points, for example, relative to a center of the screen. For example, screen space may define points in terms of micrometers in an x-dimension and a y-dimension from the center of the screen.

3D coordinates in camera space 616 may be the same as, or may be substantially similar to, 3D coordinates in camera space 606. However whereas 3D coordinates in camera space 606 is based on a coordinate system defined by a camera that captured the image of the object, 3D coordinates in camera space 616 is based on a coordinate system defined by a camera that captured an image of the display displaying the image of the object (e.g., XR device 504).

Transform 614 may be the same as, may be substantially similar to, and/or may perform the same, or substantially the same, operations as transform 604. However, whereas transform 604 transforms 3D coordinates in object space 602 to 3D coordinates in camera space 606, transform 614 transforms 3D coordinates in screen space 612 to 3D coordinates in camera space 616. For example, transform 614 may apply a transformation to transform 3D coordinates from the screen space (of the display displaying the image of the object, such as display 502) into 3D coordinates in the camera space (of the camera capturing an image of the display, such as XR device 504).

2D coordinates on image plane 620 may be the same as, or may be substantially similar to, 2D coordinates on image plane 610. However, whereas 2D coordinates on image plane 610 describes pixel locations in a display that displays an image of the object (e.g., display 502), 2D coordinates on image plane 620 may describe pixel locations in a display of a device that displays an image of a display that is displaying an image of the object (e.g., XR device 504).

Project 618 may be the same as, may be substantially similar to, and/or may perform the same, or substantially the same, operations as, project 608. However, whereas project 608 is based on a camera model of a camera that captured the image of the object, project 618 may be based on a camera model of a camera that captured an image of the display that is displaying the image of the object (e.g., XR device 504). For example, project 618 may account for distortions of XR device 504.

As mentioned previously, if XR device 504 were to try to track an object displayed in an image by display 502, XR device 504 would be unsuccessful, or minimally successful, if XR device 504 were to try to track the object based on pipeline 400. The reason being that XR device 504 would not account for all of the projections and transformations that would need to be applied in order to accurately determine 3D coordinates in the object space.

Pipeline 600 includes the translations and projections that would need to be applied to track an object based on an image of the object. According to various aspects of the present disclosure, XR device 504 may track an object, based on an image of the object, based on pipeline 600, for example, by determining or obtaining and applying the projections and transformations of pipeline 600. For example, XR device 504 may determine or obtain and apply transform 604, project 608, transform 614, and project 618 to track an object based on an image of the object.

Determining the full pipeline (e.g., pipeline 600) may be important for the tracking algorithm. Additionally, determining the full pipeline may be important for rendering virtual content relative to the object. For example, determining the full pipeline may be important for XR device 504 to be able to anchor virtual content to an object as the object appears in an image displayed by display 502.

In some aspects, XR device 504 may render virtual content anchored to the 3D object such that the virtual content appears to a user as if the virtual content was present with the object when the image of the object was captured. In other aspects, XR device 504 may render virtual content anchored to the 3D object such that the virtual content appears to the user as if the virtual content were present in the scene with XR device 504.

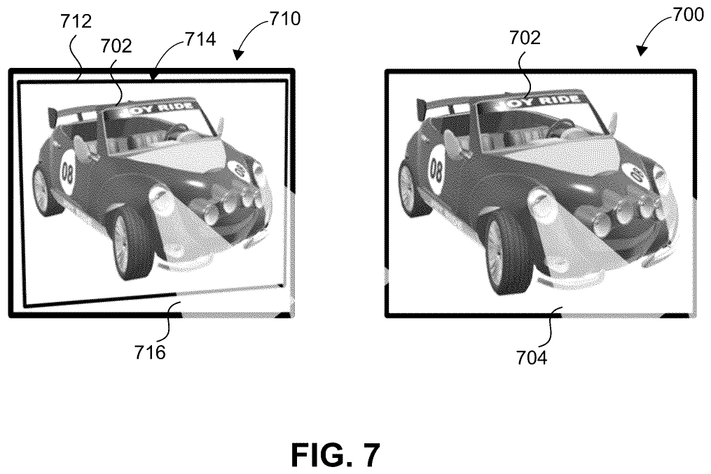

For example, FIG. 7 includes an image 700 of an object 702 including virtual content 704. For example, object 302 may be present with a user of XR device 304. The user of XR device 304 may view object 302 through XR device 304. XR device 304 may augment the user's view of object 302 by adding virtual content 704 in the user's view of object 302. For example, in some cases, XR device 304 may display image 700, including a representation of object 702 and including virtual content 704, to the user (e.g., in a video-see through (VST) or pass through mode of operation). In other cases (e.g., cases in which XR device 304 includes a transparent display), XR device 304 may display an image of virtual content 704 to the user, virtual content 704 positioned in the user's view of XR device 304 such that virtual content 704 appears to the user as if virtual content 704 were present with XR device 304.

Additionally, FIG. 7 includes an image 710 of a display 712 displaying an image 714 of object 702. For example, a user of XR device 504 may view display 502 through XR device 504. Display 502 may display image 714 of object 702. When display 502 displays image 714, display 502 may not display virtual content 716.

XR device 504 may display virtual content 716 anchored to object 702. In some aspects, XR device 504 may display virtual content 716 as if virtual content 716 were present with object 702 when image 714 of object 702 was captured. In such cases, virtual content 716 may stop at the edge of display 712 in image 710. In other aspects, XR device 504 may display virtual content 716 as if virtual content 716 were present in the scene of XR device 504. In such cases, XR device 504 may display virtual content 716 extending beyond display 712 into the scene of XR device 504 in image 710.

In some cases, XR device 504 may display image 710 including a representation of display 712 and a representation of object 702 (e.g., in a VST or pass through mode of operation). In such cases, XR device 504 may display virtual content 716 anchored to object 702 in image 710. In other cases (e.g., cases in which XR device 304 includes a transparent display), XR de vice 504 may display virtual content 716 in line with the user's view of display 712 (e.g., anchored to object 702 as displayed by display 712) without displaying a representation of object 702.

In the example illustrated with regard to FIG. 7, virtual content 704 and virtual content 716 may represent light from headlights of object 702. XR device 504 may augment the headlights of object 702 with a light cone, regardless if object 702 is observed via display 502 or if object 702 is present with XR device 504. The virtual content 704 or virtual content 716 should be presented in both cases as if the light comes out of the physical headlights at the correct angles, regardless if the object is observed in the real world, or by looking at a rendered/captured video footage on a screen.

XR device 504 may have an operational mode for anchoring virtual content to objects that are present (e.g., as illustrated and described with regard to FIG. 3) and an operational mode for anchoring virtual content to objects that are not present but displayed via a display (e.g., as illustrated and described with regard to FIG. 5). For example, XR device 504 may use principles described with regard to pipeline 400 to anchor virtual content in situations like those illustrated by FIG. 3. Also, XR device 504 may use principles described with regard to pipeline 600 to anchor virtual content in situations like those illustrated by FIG. 5.

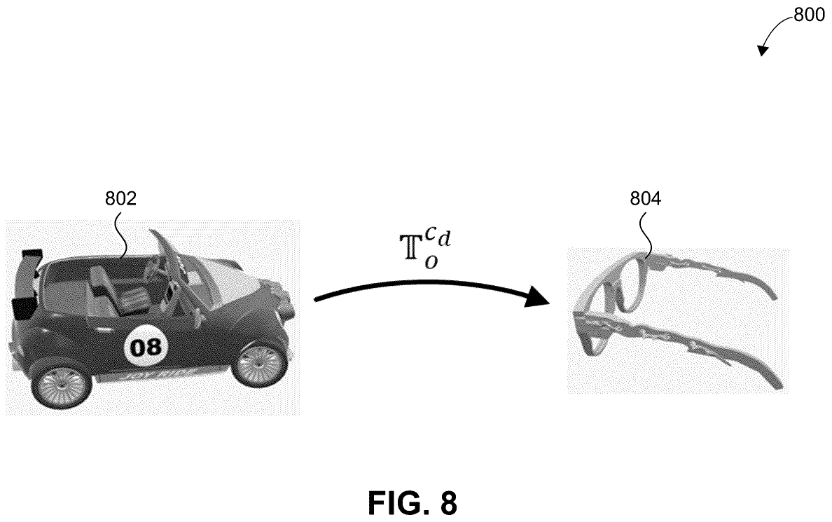

FIG. 8 is a diagram illustrating an example system 800 in which an XR device 804 determines and/or applies a transformation

$${𝕋}_{o}^{{c}_{d}} ,$$

according to various aspects of the present disclosure. When observing object 802 in the real world, a tracking algorithm of XR device 804 may estimate the 6DoF object-to-device-camera transformation

$${𝕋}_{o}^{{c}_{d}}$$

(which may also be referred to as an object-to-camera transformation), given an object reference in object space and device camera parameters. In the present disclosure, the term “pose” may refer to a description of a position and orientation of an object according to six degrees of freedom (e.g., three translational degrees of freedom and three rotational degrees of freedom). Knowing a pose of an object in one coordinate space and a pose of the object in another coordinate space, it may be possible to determine a transformation between the two coordinate spaces. In some cases, the term “pose” may be used to refer to a transformation between coordinate spaces.

$${𝕋}_{o}^{{c}_{d}}$$

may be a representation of the transformation of transform 404 of FIG. 4.

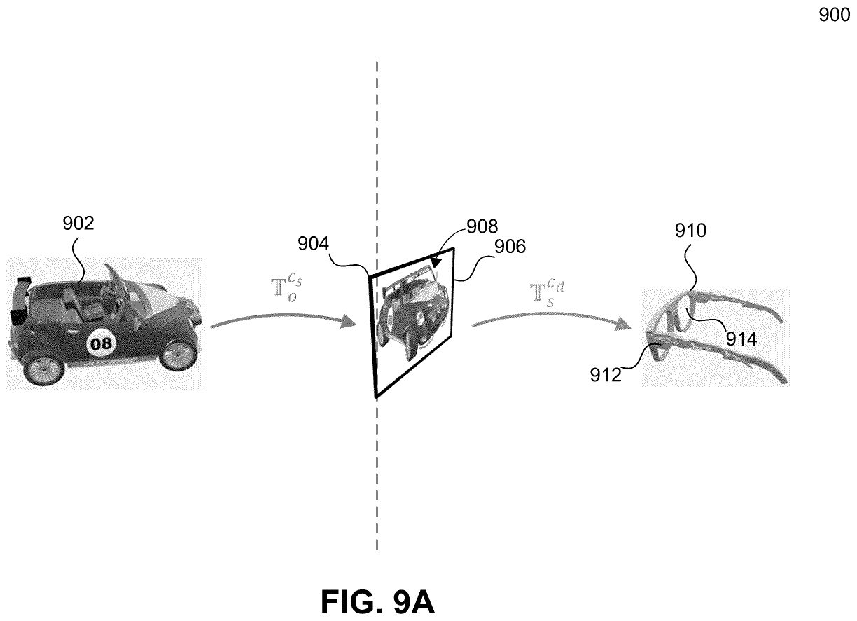

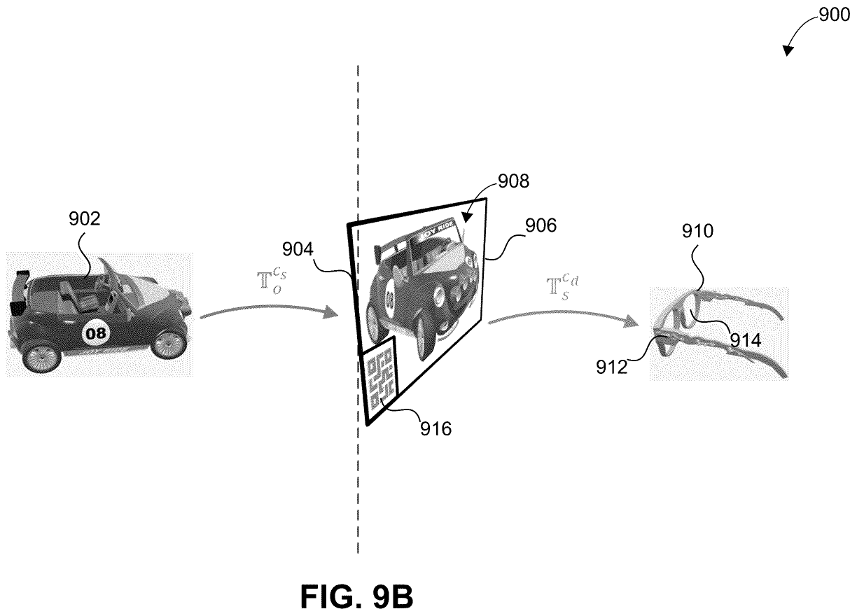

FIG. 9A is a diagram illustrating an example system 900 in which an XR device 910 determines and/or applies a transformation

$${𝕋}_{s}^{{c}_{d}}$$

and a transformation

$${𝕋}_{o}^{{c}_{s}} ,$$

according to various aspects of the present disclosure. In general, a camera 904 may capture an image 908 of an object 902. A display 906 may display image 908. Display 906 may, or may not, be part of the same device as camera 904. Display 906 may display image 908 at substantially the same time that camera 904 captures image 908 or at a later time. The dashed line in FIG. 9A represents a spatial and/or temporal separation between camera 904 capturing image 908 of object 902 and display 906 displaying image 908. A camera 912 of XR device 910 may capture an image of display 906 displaying image 908. A tracking algorithm of XR device 910 may track object 902 based on the captured image of display 906. In some aspects, XR device 910 may display virtual content at display 914 that is anchored based on object 902.

When XR device 910 observes object 902 via a screen (in other words, when XR device 910 captures an image of an image 908 of object 902 as displayed by display 906), a tracking algorithm of XR device 910 may estimate the 6DoF object-to-render-camera transformation

$${𝕋}_{o}^{{c}_{s}} .$$

Additionally, to accurately configure the tracking algorithm for this scenario, the tracking algorithm may use a camera projection of camera 912 of XR device 910, the screen-to-device-camera transformation

$${𝕋}_{s}^{{c}_{d}}$$

(which may be referred to as a display-to-camera transformation) of XR device 910 and a camera projection of camera 904 (which may be referred to as Pₛ or a first-camera projection).

$${𝕋}_{o}^{{c}_{s}}$$

may be a representation of the transformation of transform 604 of FIG. 6.

$${𝕋}_{s}^{{c}_{d}}$$

may be a representation of the transformation of transform 614 of FIG. 6. Additionally, there may be a projection based on a camera model of camera 904 that may determine how the image of object 902 is displayed at display 906. Such a projection is the projection of project 608 of FIG. 6. Further, there may be a projection based on a camera model of camera 912 of XR device 910. Such a projection is the projection of project 618 of FIG. 6.

In order for a tracking algorithm of XR device 910 to track object 902 based on image 908, the tracking algorithm may use,

$${𝕋}_{o}^{{c}_{s}} ,$$

(e.g., transform 604), a projection of camera 904 (e.g., project 608 or Pₛ),

$${𝕋}_{s}^{{c}_{d}}$$

(e.g., transform 614), and a projection of camera 912 (e.g., project 618 or Pa).

XR device 910 may have the projection of camera 912—P_{d}. The projection of camera 912 may be based on components and/or calibration of camera 912. XR device 910 may be configured with the projection of camera 912.

XR device 910 may track display 906 to determine

$${𝕋}_{s}^{{c}_{d}} .$$

For example, XR device 910 may use a tracking algorithm to determine a pose of display 906 in the coordinate system of camera 912. Further, XR device 910 may define a coordinate system based on display 906 and determine a transformation between the coordinate system of camera 912 and the coordinate system based on display 906.

Display 906 may provide the projection of camera 904 to XR device 910. For example, display 906 may include a wireless communication unit and may wirelessly transmit the projection to XR device 910. As another example, display 906 may display the projection visually encoded (e.g., as a quick response (QR) code).

XR device 910 may track object 902 based on the projection of camera 912,

$${𝕋}_{o}^{{c}_{d}} ,$$

and the projection of camera 904 to determine

$${𝕋}_{o}^{{c}_{s}} .$$

For example, XR device 910 may employ a tracking algorithm, configure according to pipeline 600, and with the knowledge of projection of camera 912,

$${𝕋}_{s}^{{c}_{d}} .$$

and the projection of camera 904 to determine

$${𝕋}_{o}^{{c}_{s}} .$$

Once XR device 910 has determined

$${𝕋}_{o}^{{c}_{s}} ,$$

XR device 910 may anchor virtual content based on object 902 and render images of the virtual content at display 914. For example, XR device 910 may use

$${𝕋}_{o}^{{c}_{s}} ,$$

at transform 604, the projection of camera 904 at project 608,

$${𝕋}_{s}^{{c}_{d}}$$

at transform 614, and the projection of camera 912 at project 618 to anchor virtual content relative to object 902.

The full pipeline from 3D object space of object 902 to camera space of camera 912 may be expressed as:

$${x}_{2 d} = {P}_{d} ( {𝕋}_{s}^{{c}_{d}} . ( {S}_{px}^{w} ( {P}_{s} ( {𝕋}_{o}^{{c}_{s}} . ( {X}_{3 D} ) ) ) ) )$$

In the representation of the pipeline, X_{3D} represents the 3D reference information (e.g., 3D coordinates of 3D points, 3D line segments, 3D object meshes, or other trackable information about object 902) in the object reference coordinate space. For example, X_{3D} represents trackable points of object 902.

$${𝕋}_{o}^{{c}_{s}}$$

represents a function defining the transformation from the 3D object reference system to the reference system of camera 904.

$${𝕋}_{o}^{{c}_{s}} ,$$

is a representation of the transformation of transform 604 of FIG. 6.

$${𝕋}_{o}^{{c}_{s}}$$

may be estimated by the XR device 910.

$${𝕋}_{o}^{{c}_{s}}$$

may be referred to as an object-to-camera transformation.

Pₛ represents the projection function used by camera 904 to generate image 908 of the 3D scene. Pₛ may map 3D coordinates in the system of the camera 904 to image pixels of image 908. Pₓ is a representation of the projection of project 608 of FIG. 6. Display 906 may provide Pₛ to XR device 910 (e.g., through a wireless transmission or through a visually encoded message, such as a QR code). Pₛ may be referred to as a first-camera projection.

$${S}_{p x}^{w}$$

represents a function that maps the 2D pixel coordinates of display 906 to 3D coordinates in the system of the display 906.

$${S}_{p x}^{w}$$

is a representation of mapping 625 of FIG. 6. The output of

$${S}_{p x}^{w}$$

could be 3D coordinates in metric units, where the z-component is 0 in the case the screen is defined as x/y plane. In some cases, XR device 910 may infer

$${S}_{p x}^{w}$$

(which may include a scaling and an optional shift of the coordinate center). Inferring

$${S}_{p x}^{w}$$

may involve determining the physical size of the screen, which may be accomplished, for example, by reading a configuration file, determining the screen type and looking up a size in a database, requesting a screen size from the screen, and/or user input.

$${S}_{p x}^{w}$$

may be referred to as a scaling function.

$${𝕋}_{s}^{{c}_{d}}$$

represents a function defining the transformation from screen coordinates of display 906 to 2D coordinates of an image plane as captured by camera 912 of XR device 910.

$${𝕋}_{s}^{{c}_{d}}$$

is a representation of the transformation of transform 614 of FIG. 6.

$${𝕋}_{s}^{{c}_{d}}$$

may be in the form of a pose matrix. The pose may be estimated by an object tracker of XR device 910.

$${𝕋}_{s}^{{c}_{d}}$$

may be referred to as a display-to-camera transformation.

P_{d} represents the projection function of camera 912. P_{d} may is a representation of the projection of project 618 of FIG. 6. XR device 910 may be preconfigured with P_{d} based on components and calibration of camera 912. P_{d} may be determined a priori or updated during operation of camera 912. P_{d} may be referred to as a second-camera projection.

x_{2d} represents the 2D pixel position of the image 908 as captured by camera 912.

FIG. 9B includes an alternate view of system 900 in which display 906 displays a QR code 916, according to various aspects of the present disclosure. In some aspects, QR code 916 may encode data that XR device 910 may use to track object 902. For example, display 906 may encode QR code 916 to encode projection Pₛ of camera 904. XR device 910 may decode QR code 916 to obtain Pₛ and track object 902 based on Pₛ.

Additionally or alternatively, XR device 910 may track display 906 (e.g., to determine

$${𝕋}_{s}^{{c}_{d}} )$$

based on QR code 916. For example, if image 908 is a frame of video data, a subsequent frame displayed at display 906 may be different from image 908. It may be difficult for an object tracker to track display 906 if display 906 displays different images over time. However, if display 906 displays QR code 916 consistently, the object tracker of XR device 910 may track display 906 based on QR code 916.

Additionally or alternatively, XR device 910 may interpret QR code 916 as a cue regarding a mode of operation of a tracker of XR device 910. For example, XR device 910 may, by default, attempt to track objects as if the objects were present (e.g., as illustrated and described with regard to FIG. 3). However, if XR device 910 detects QR code 916, XR device 910 may use the detected QR code 916 as a cue to attempt to track objects as if the objects are not present but instead were displayed in an image (e.g., as illustrated and described with regard to FIG. 5).

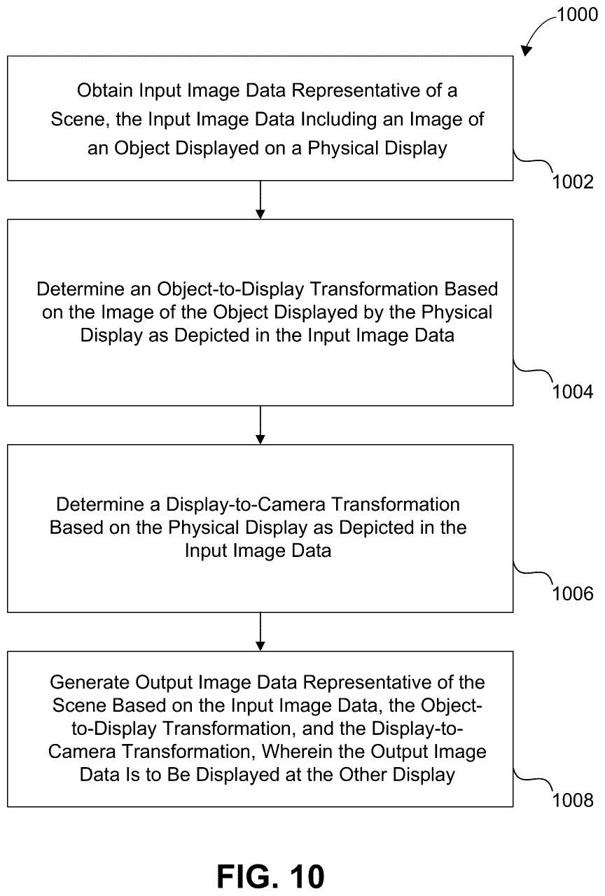

FIG. 10 is a flow diagram illustrating an example process 1000 for tracking objects, in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1000. The one or more operations of process 1000 may be implemented as software components that are executed and run on one or more processors.

At block 1002, a computing device (or one or more components thereof) may obtain input image data representative of a scene, the input image data including an image of an object displayed on a physical display. For example, camera 912 of XR device 910 may capture an image representative of a scene. Display 906 may be in the scene and may be displaying an image of object 902. As such, the image captured by camera 912 may include an image of object 902 displayed at display 906.

At block 1004, the computing device (or one or more components thereof) may determine an object-to-camera transformation based on the image of the object displayed by the physical display as depicted in the input image data. For example, XR device 910 may determine

$${𝕋}_{o}^{{c}_{s}}$$

In some aspects, the object-to-camera transformation may describe a relationship between a coordinate system based on the object and a coordinate system based on the physical display. For example, the object-to-camera transformation may be

$${𝕋}_{o}^{{c}_{s}} .$$

### Where

$${𝕋}_{o}^{{c}_{s}}$$

may describe a relationship between a coordinate system based on object 902 and a coordinate system based on display 906.

In some aspects, to determine the object-to-camera transformation, the computing device (or one or more components thereof) may estimate the object-to-camera transformation based on the image of the object as displayed by the physical display as depicted in the input image data. For example, XR device 910 may estimate

$${𝕋}_{o}^{{c}_{s}}$$

based on image 908 of object 902 as displayed by display 906.

In some aspects, the computing device (or one or more components thereof) may determine a first-camera projection based on intrinsic parameters of the camera associated with the image. The output image data (generated at block 1008) may be generated based on the first-camera projection. For example, XR device 910 may determine a first-camera projection Pₛ. Pₛ may be a projection function describing a camera that captured image 908.

In some aspects, the intrinsic parameters of the camera associated with the image comprise a focal length of a lens of the camera and distortions of the lens. For example, Pₛ may be determined based on intrinsic parameters of the camera associated with image 908. For example, Pₛ may be, or may include, a focal length of a lens of the camera and distortions of the lens.

In some aspects, the computing device (or one or more components thereof) may receive the intrinsic parameters of the camera associated with the image from the physical display. For example, display 906 may transmit Pₛ to XR device 910.

In some aspects, the computing device (or one or more components thereof) may determine the intrinsic parameters based on a quick response (QR) code displayed by the physical display. For example, display 906 may display QR code 916 and XR device 910 may determine Pₛ based on QR code 916.

At block 1006, the computing device (or one or more components thereof) may determine a display-to-camera transformation based on the physical display as depicted in the input image data. For example, XR device 910 may determine

$${𝕋}_{s}^{{c}_{d}} .$$

In some aspects, the display-to-camera transformation may describe a relationship between a coordinate system based on the physical display and a coordinate system based on a camera associated with the input image data. For example,

$${𝕋}_{s}^{{c}_{d}}$$

may describe a relationship between a coordinate system based on the display 906 and a coordinate system based on camera 912.

In some aspects, to determine the display-to-camera transformation, the computing device (or one or more components thereof) may track the physical display as depicted in the input image data using an object tracker. For example, XR device 910 may track display 906 as depicted in images captured by camera 912.

In some aspects, to track the physical display, the computing device (or one or more components thereof) may track a quick response (QR) code displayed by the physical display. For example, XR device 910 may track QR code 916 in images of display 906 captured by camera 912.

In some aspects, the computing device (or one or more components thereof) may determine a second-camera projection based on intrinsic parameters of the camera associated with the input image data. The output image data (generated at block 1008) may be generated based on the second-camera projection. For example, XR device 910 may determine P_{d}. XR device 910 may determine the second-camera projection P_{d} based on intrinsic parameters associated with camera 912.

In some aspects, the computing device (or one or more components thereof) may determine a scaling function based on pixels of the physical display depicted in the input image data. The output image data (generated at block 1008) may be generated based on the scaling function. For example, XR device 910 may determine Sₚₓ^{w} based on pixels of display 906 as depicted in the image captured by camera 912.

In some aspects, the computing device (or one or more components thereof) may detect a quick response (QR) code in the input image data; and determine to determine the display-to-camera transformation based on the QR code. For example, XR device 910 may detect QR code 916 in images captured by camera 912. Further, XR device 910 may determine to determine based on detecting QR code 916.

At block 1008, the computing device (or one or more components thereof) may generate output image data representative of the scene based on the input image data, the object-to-camera transformation, and the display-to-camera transformation, wherein the output image data is to be displayed at a second display.

In some aspects, to generate the output image data, the at least one processor is configured to anchor virtual content in the scene relative to the object based on the object-to-camera transformation and the display-to-camera transformation. For example, XR device 910 may generate image data to display at display 914. XR device 910 may anchor virtual content to the scene of XR device 910 based on

$${𝕋}_{o}^{{c}_{s}} and {𝕋}_{s}^{{c}_{d}} .$$

In some examples, as noted previously, the methods described herein (e.g., process 1000 of FIG. 10, and/or other methods described herein) can be performed, in whole or in part, by a computing device or apparatus. In one example, one or more of the methods can be performed by XR device 102 of FIG. 1, XR system 200 of FIG. 2, XR device 304 of FIG. 3, pipeline 400 of FIG. 4, XR device 504 of FIG. 5, pipeline 600 of FIG. 6, XR device 804 of FIG. 8, XR device 910 of FIG. 9A and FIG. 9B, or by another system or device. In another example, one or more of the methods (e.g., process 1000, and/or other methods described herein) can be performed, in whole or in part, by the computing-device architecture 1100 shown in FIG. 11. For instance, a computing device with the computing-device architecture 1100 shown in FIG. 11 can include, or be included in, the components of the XR device 102 of FIG. 1, XR system 200 of FIG. 2, XR device 304 of FIG. 3, pipeline 400 of FIG. 4, XR device 504 of FIG. 5, pipeline 600 of FIG. 6, XR device 804 of FIG. 8, and/or XR device 910 of FIG. 9A and FIG. 9B, and can implement the operations of process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of XR device 102 of FIG. 1, XR system 200 of FIG. 2, XR device 304 of FIG. 3, pipeline 400 of FIG. 4, XR device 504 of FIG. 5, pipeline 600 of FIG. 6, XR device 804 of FIG. 8, XR device 910 of FIG. 9A and FIG. 9B, and/or other devices, modules, or systems described herein. Additionally or alternatively, computing-device architecture 1100 may be configured to perform process 1000, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for tracking objects, the apparatus comprising: at least one memory; and at least one processor coupled to the at least one memory and configured to: obtain input image data representative of a scene, the input image data including an image of an object displayed on a physical display; determine an object-to-camera transformation based on the image of the object displayed by the physical display as depicted in the input image data; determine a display-to-camera transformation based on the physical display as depicted in the input image data; and generate output image data representative of the scene based on the input image data, the object-to-camera transformation, and the display-to-camera transformation, wherein the output image data is to be displayed at a second display.

Aspect 2. The apparatus of aspect 1, wherein, to generate the output image data, the at least one processor is configured to anchor virtual content in the scene relative to the object based on the object-to-camera transformation and the display-to-camera transformation.

Aspect 3. The apparatus of any one of aspects 1 or 2, wherein the object-to-camera transformation describes a relationship between a coordinate system based on the object and a coordinate system based on the physical display.

Aspect 4. The apparatus of any one of aspects 1 to 3, wherein, to determine the object-to-camera transformation, the at least one processor is configured to estimate the object-to-camera transformation based on the image of the object as displayed by the physical display as depicted in the input image data.

Aspect 5. The apparatus of any one of aspects 1 to, wherein the at least one processor is configured to determine a first-camera projection based on intrinsic parameters of a camera associated with the image wherein the output image data is generated further based on the first-camera projection.

Aspect 6. The apparatus of aspect 5, wherein the intrinsic parameters of the camera associated with the image comprise a focal length of a lens of the camera and distortions of the lens.

Aspect 7. The apparatus of any one of aspects 5 or 6, wherein the at least one processor is configured to receive the intrinsic parameters of the camera associated with the image from the physical display.

Aspect 8. The apparatus of any one of aspects 5 to 7, wherein the at least one processor is configured to determine the intrinsic parameters based on a quick response (QR) code displayed by the physical display.

Aspect 9. The apparatus of any one of aspects 1 to 8, wherein the display-to-camera transformation describes a relationship between a coordinate system based on the physical display and a coordinate system based on a camera associated with the input image data.

Aspect 10. The apparatus of any one of aspects 1 to 9, wherein, to determine the display-to-camera transformation, the at least one processor is configured to track the physical display as depicted in the input image data using an object tracker.

Aspect 11. The apparatus of aspect 10, wherein, to track the physical display, the at least one processor is configured to track a quick response (QR) code displayed by the physical display.

Aspect 12. The apparatus of any one of aspects 1 to 11, wherein the at least one processor is configured to determine a second-camera projection based on intrinsic parameters of a camera associated with the input image data, wherein the output image data is generated further based on the second-camera projection.

Aspect 13. The apparatus of aspect 12, wherein the at least one processor is configured to determine a scaling function based on pixels of the physical display depicted in the input image data, wherein the output image data is generated further based on the scaling function.

Aspect 14. The apparatus of any one of aspects 1 to 13, wherein the at least one processor is configured to: detect a quick response (QR) code in the input image data; and determine to determine the display-to-camera transformation based on the QR code.

Aspect 15. A method for tracking objects, the method comprising: obtaining input image data representative of a scene, the input image data including an image of an object displayed on a physical display; determining an object-to-camera transformation based on the image of the object displayed by the physical display as depicted in the input image data; determining a display-to-camera transformation based on the physical display as depicted in the input image data; and generating output image data representative of the scene based on the input image data, the object-to-camera transformation, and the display-to-camera transformation, wherein the output image data is to be displayed at a second display.

Aspect 16. The method of aspect 15, wherein generating the output image data further comprising anchoring virtual content in the scene relative to the object based on the object-to-camera transformation and the display-to-camera transformation.

Aspect 17. The method of any one of aspects 15 or 16, wherein the object-to-camera transformation describes a relationship between a coordinate system based on the object and a coordinate system based on the physical display.

Aspect 18. The method of any one of aspects 15 to 17, wherein determining the object-to-camera transformation further comprising estimating the object-to-camera transformation based on the image of the object as displayed by the physical display as depicted in the input image data.

Aspect 19. The method of any one of aspects 15 to 18, further comprising determining a first-camera projection based on intrinsic parameters of a camera associated with the image wherein the output image data is generated further based on the first-camera projection.

Aspect 20. The method of aspect 19, wherein the intrinsic parameters of the camera associated with the image comprise a focal length of a lens of the camera and distortions of the lens.

Aspect 21. The method of any one of aspects 19 or 20, further comprising receiving the intrinsic parameters of the camera associated with the image from the physical display.

Aspect 22. The method of any one of aspects 19 to 21, further comprising determining the intrinsic parameters based on a quick response (QR) code displayed by the physical display.

Aspect 23. The method of any one of aspects 15 to 22, wherein the display-to-camera transformation describes a relationship between a coordinate system based on the physical display and a coordinate system based on a camera associated with the input image data.

Aspect 24. The method of any one of aspects 15 to 23, wherein determining the display-to-camera transformation further comprising tracking the physical display as depicted in the input image data using an object tracker.

Aspect 25. The method of aspect 24, wherein tracking the physical display further comprising tracking a quick response (QR) code displayed by the physical display.

Aspect 26. The method of any one of aspects 15 to 25, further comprising determining a second-camera projection based on intrinsic parameters of a camera associated with the input image data, wherein the output image data is generated further based on the second-camera projection.

Aspect 27. The method of aspect 26, further comprising determining a scaling function based on pixels of the physical display depicted in the input image data, wherein the output image data is generated further based on the scaling function.

Aspect 28. The method of any one of aspects 15 to 27, further comprising: detecting a quick response (QR) code in the input image data; and determining to determine the display-to-camera transformation based on the QR code.

Aspect 29. A non-transitory computer-readable storage medium having stored thereon instructions that, when executed by at least one processor, cause the at least one processor to perform operations according to any of aspects 15 to 28.

Aspect 30. An apparatus for providing virtual content for display, the apparatus comprising one or more means for perform operations according to any of aspects 15 to 28.

What is claimed is:

1. An apparatus for tracking objects, the apparatus comprising:
at least one memory; and
at least one processor coupled to the at least one memory and configured to:
obtain input image data representative of a scene, the input image data including an image of an object displayed on a physical display;
determine an object-to-camera transformation based on the image of the object displayed by the physical display as depicted in the input image data;
determine a display-to-camera transformation based on the physical display as depicted in the input image data; and
generate output image data representative of the scene based on the input image data, the object-to-camera transformation, and the display-to-camera transformation, wherein the output image data is to be displayed at a second display.

2. The apparatus of claim 1, wherein, to generate the output image data, the at least one processor is configured to anchor virtual content in the scene relative to the object based on the object-to-camera transformation and the display-to-camera transformation.

3. The apparatus of claim 1, wherein the object-to-camera transformation describes a relationship between a coordinate system based on the object and a coordinate system based on the physical display.

4. The apparatus of claim 1, wherein, to determine the object-to-camera transformation, the at least one processor is configured to estimate the object-to-camera transformation based on the image of the object as displayed by the physical display as depicted in the input image data.

5. The apparatus of claim 1, wherein the at least one processor is configured to determine a first-camera projection based on intrinsic parameters of a camera associated with the image wherein the output image data is generated further based on the first-camera projection.

6. The apparatus of claim 5, wherein the intrinsic parameters of the camera associated with the image comprise a focal length of a lens of the camera and distortions of the lens.

7. The apparatus of claim 5, wherein the at least one processor is configured to receive the intrinsic parameters of the camera associated with the image from the physical display.

8. The apparatus of claim 5, wherein the at least one processor is configured to determine the intrinsic parameters based on a quick response (QR) code displayed by the physical display.

9. The apparatus of claim 1, wherein the display-to-camera transformation describes a relationship between a coordinate system based on the physical display and a coordinate system based on a camera associated with the input image data.

10. The apparatus of claim 1, wherein, to determine the display-to-camera transformation, the at least one processor is configured to track the physical display as depicted in the input image data using an object tracker.

11. The apparatus of claim 10, wherein, to track the physical display, the at least one processor is configured to track a quick response (QR) code displayed by the physical display.

12. The apparatus of claim 1, wherein the at least one processor is configured to determine a second-camera projection based on intrinsic parameters of a camera associated with the input image data, wherein the output image data is generated further based on the second-camera projection.

13. The apparatus of claim 12, wherein the at least one processor is configured to determine a scaling function based on pixels of the physical display depicted in the input image data, wherein the output image data is generated further based on the scaling function.

14. The apparatus of claim 1, wherein the at least one processor is configured to:
detect a quick response (QR) code in the input image data; and
determine to determine the display-to-camera transformation based on the QR code.

15. A method for tracking objects, the method comprising:
obtaining input image data representative of a scene, the input image data including an image of an object displayed on a physical display;
determining an object-to-camera transformation based on the image of the object displayed by the physical display as depicted in the input image data;
determining a display-to-camera transformation based on the physical display as depicted in the input image data; and
generating output image data representative of the scene based on the input image data, the object-to-camera transformation, and the display-to-camera transformation, wherein the output image data is to be displayed at a second display.

16. The method of claim 15, wherein generating the output image data further comprising anchoring virtual content in the scene relative to the object based on the object-to-camera transformation and the display-to-camera transformation.

17. The method of claim 15, wherein the object-to-camera transformation describes a relationship between a coordinate system based on the object and a coordinate system based on the physical display.

18. The method of claim 15, wherein determining the object-to-camera transformation further comprising estimating the object-to-camera transformation based on the image of the object as displayed by the physical display as depicted in the input image data.

19. The method of claim 15, further comprising determining a first-camera projection based on intrinsic parameters of a camera associated with the image wherein the output image data is generated further based on the first-camera projection.

20. The method of claim 19, wherein the intrinsic parameters of the camera associated with the image comprise a focal length of a lens of the camera and distortions of the lens.
